(19) United States
(12) Patent Application Publication
(10) Pub. No.: US 2005/0210688 A1
(43) Pub. Date: Sep. 29, 2005

(54) Visual protractor

(76) Inventor: Mary Lu Stephens, Cincinnati, OH (US)

Correspondence Address: WOOD, HERRON & EVANS, LLP, 2700 CAREW TOWER, 441 VINE STREET, CINCINNATI, OH, 45202, US

(21) Appl. No.: 10/889,873

(22) Filed: Jul. 13, 2004

Related U.S. Application Data
(60) Provisional application No. 60/557,223, filed on Mar. 29, 2004.

(51) Int. Cl. G01D 21/00

(52) U.S. Cl. 33/1 N

(57) ABSTRACT

A visual protractor is disclosed that reduces the time to teach students how to measure and understand angles and significantly improves overall student comprehension of angles. The protractor offers a significant increase in convenience in measuring and drawing angles.

### CROSS-REFERENCE TO RELATED APPLICATIONS

This non-provisional patent application claims the benefit of U.S. provisional patent application Ser. No. 60/557,223 filed Mar. 29, 2004, which is herein incorporated by reference in its entirety.

### FIELD OF THE INVENTION

This invention relates generally to visual devices such as a protractor and more particularly to a colored protractor for use in teaching.

### BACKGROUND OF THE INVENTION

The protractor is an ancient instrument which in its simplest form comprises of a semi-circular disc with angle indicia ranging from zero to 180 degrees on its circumference. Such devices were conventionally used in astronomical studies. Variations developed on the protractor include providing means for drawing angles, dividing angles, combination protractors comprising of angle measurement and linear measurement, etc.

In 1993, the National Assessment of Education Progress in the United States reported that only one-third of eighth graders using conventional protractors could successfully measure a 127 degree angle. Allowance was provided on either side of 127 degrees such that any answer between 124 and 130 degrees was tabulated as correct. Thus, the use of conventional semi-circular protractors has been accompanied by ambiguities that reduce student comprehension.

The broad concept of using a multi piece protractor for measuring and drawing angles is known. For example, U.S. Pat. No. 5,588,218 discloses a protractor comprising two flat pieces pivotally joined together, each having a straight edge radial to the pivot point to help students measure and draw angles. The teaching protractor disclosed in this patent is difficult to use and fails to utilize color as a teaching aide.

Therefore, there is a need for a teaching protractor which utilizes color as a tool to help children to measure and understand angles easily. There is further a need for a teaching protractor having a circular disk member rotatable relative to another circular disc member to produce a visual display of the angle being measured.

Therefore, it is an object of the present invention to provide a protractor that enables a user, particularly a young student of geometry, to rapidly and accurately visualize and measure angles.

It is a further object of the present invention to provide a colored visual display of the angle being measured that is not available in conventional protractors.

### SUMMARY OF THE INVENTION

This invention relates generally to visual devices such as a protractor and more particularly to a colored protractor for teaching purposes. The present invention eliminates the ambiguities and inaccuracies that accompany the use of conventional half-moon protractors.

One aspect of the present invention comprises a protractor or angle viewer that enables a user or student to rapidly and precisely measure and draw angles. This aspect of the present invention comprises three flat disc members with two of the three disc members being rotatably joined together. The first flat disc member is a clear backing member; the second disc member is colored and the third disc member has indicia along its outer periphery. In one embodiment this indicia goes from 0 to 360 degrees. The second disc member may be rotatably sandwiched between the first and third disc members and has a tab extending outwardly from its outer edge to enable a user to grasp the tab to rotate the second disc member.

A second aspect of the present invention comprises what will be referred to as a half circle or 180 degree angle finder. This aspect of the present invention comprises three flat disc members with two of the three disc members being rotatably joined together. The first flat disc member is a backing member. The second disc member has indicia along its outer periphery and a portion thereof is divided into two semi-circles by color. This second disc member is joined to the first backing disc member. In one embodiment, one of the semi-circles is colored red and the other semi-circle is colored yellow. Along the periphery of each semi-circle, the indicia go from 0 to 180 degrees and are different colors. A third disc member is rotatably joined to the second disc member. The third disc member is divided into two semi-circles, one being colored and the other being clear. The third disc member has a tab extending outwardly from its outer edge to enable a user to grasp the tab to rotate the third disc member. In one embodiment, half the third disc member is colored blue and half the disc member is clear.

The first two aspects of the present invention help students visualize angles, measure angles correctly, understand angles and their relationships, and draw angles easily and accurately.

A third aspect of the present invention comprises what will be referred to as a fraction viewer. This aspect of the present invention comprises two flat disc members rotatably joined together and is used to teach students about fractions. The first flat disc member is a backing member having indicia along its outer periphery and has a radial slot therein. The second disc member is rotatably joined to the first disc member. A portion of the second disc member may pass through the radial slot and be rotated above or on top of the first disc member. The second disc member has a tab extending outwardly from its outer edge to enable a user to grasp the tab to rotate the second disc member. In one embodiment the second disc member is colored red. By grasping the tab and rotating the second disc member relative to the stationary first disc member, a user can visualize any desired angle fraction.

### BRIEF DESCRIPTION OF THE DRAWINGS

FIG. 1 is a top plan view of a 360 degree angle finder or protractor according to one aspect of the present invention.

FIG. 2 is a top plan view of the first disc member of the protractor of FIG. 1.

FIG. 3 is a top plan view of the second disc member of the protractor of FIG. 1.

FIG. 4 is a top plan view of the third disc member of the protractor of FIG. 1.

FIG. 5 is a top plan view of a 180 degree angle finder or protractor according to a second aspect of the present invention.

FIG. 6 is a top plan view of the second disc member of the protractor of FIG. 5.

FIG. 7 is a top plan view of the third disc member of the protractor of FIG. 5.

FIG. 8 is a top plan view of a fraction viewer according to a third aspect of the present invention.

FIG. 9 is a top plan view of the first disc member of the fraction viewer of FIG. 8.

FIG. 10 is a top plan view of the second disc member of the fraction viewer of FIG. 8.

FIG. 11 is a top plan view of another embodiment of the fraction viewer of the present invention.

FIG. 12 is a top plan view of another embodiment of the fraction viewer of the present invention.

FIG. 13 is a top plan view of another embodiment of the fraction viewer of the present invention.

### DETAILED DESCRIPTION OF THE DRAWINGS

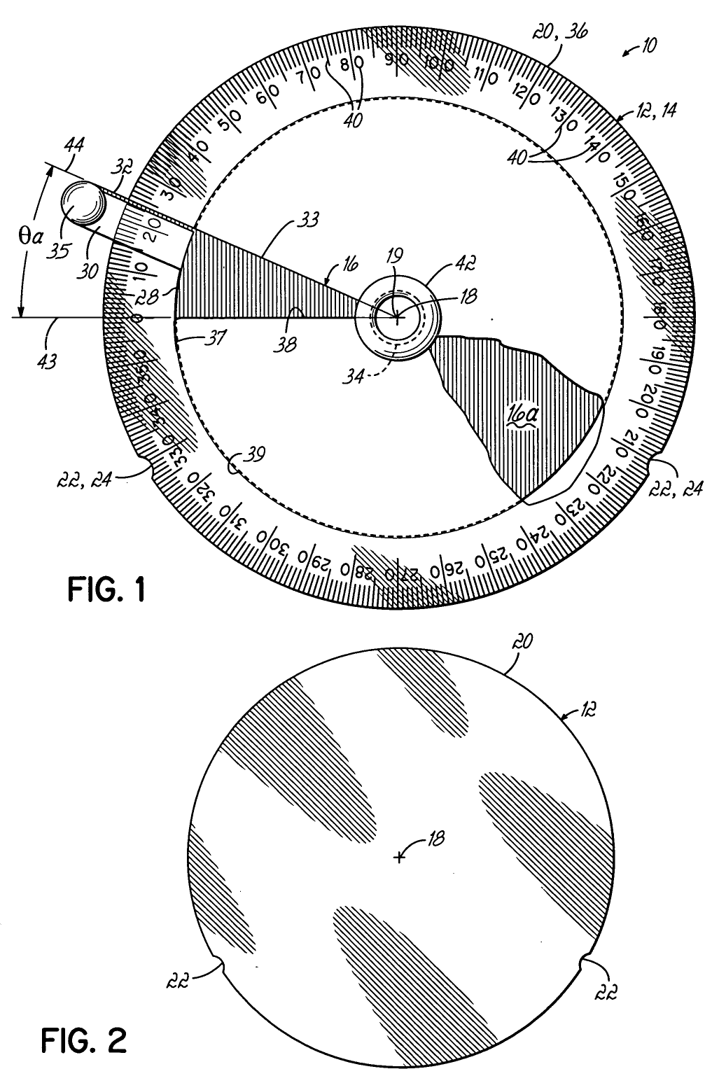

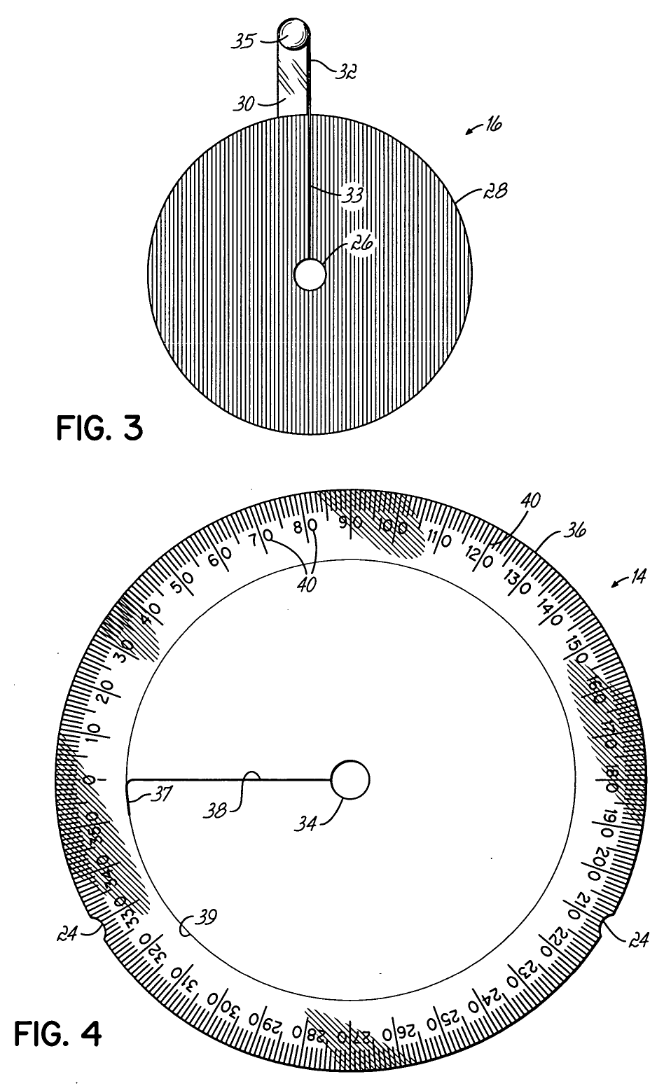

With reference to FIGS. 1-4, one aspect of the present invention is illustrated. Specifically, FIG. 1 shows an assembled 360 degree angle finder or protractor 10 comprising a generally flat clear first disc member 12, and generally flat second and third disc members 16 and 14. FIG. 2 illustrates the generally flat clear first disc member 12 of the protractor 10. Adhesive (not shown) is secured around the periphery of the first disc member 12 in order to secure the third disc member 14, shown in FIG. 4, to the first disc member 12 with a second disc member 16, shown in FIG. 3, sandwiched therebetween. Any other desired securing means, e.g. tape, may be used for joining the first and third discs 12, 14 together.

Referring to FIG. 2 (FIG. 2 not drawn to scale), the first disc member 12 has a center point 18 and an outside or peripheral edge 20. When assembled, the center point 18 of the first disc member 12 is located in the center of a center hole 34 of the third disc member 14. The center point 18 is adapted for placement over a vertex 19, i.e. the intersection of two lines 43 and 44, when the proctractor 10 is used to measure an angle (θₐ) between the lines 43, 44 (See FIG. 1). Along the outside edge 20 of the first disc member 12 are two indentations or markers 22 which match up with the same markers 24 on the third disc member 14 (See FIG. 4) when the protractor 10 is assembled.

FIG. 3 (not drawn to scale) illustrates the second disc member 16 having a circular center hole 26, an outer or peripheral edge 28, and a tab 30 extending outwardly from the outer edge 28 of the periphery. The tab 30 has a marked straight edge 32 on one side, which enables a user to draw a straight line along the straight edge 32, and has a boss portion 35 for easier movement thereof. The marked edge 32 further helps a user indicate the indicia 40 (FIGS. 1 and 4) to determine the angle (θₐ) being measured. While it should be understood by the artisan that any color may be used, the second disc member 16 advantageously is colored red. The coloring helps to produce a visual display when the protractor 10 is used to measure an angle between two intersecting lines. The second disc member 16 also has a radial slit 33 which enables the second disc member 16 to pass through a slot 38 (See FIG. 4) in the third disc member 14 and rotate above and below the third disc member 14.

FIG. 4 illustrates the third disc member 14 having a circular center hole 34, an outer or peripheral edge 36, and the radial slot 38 extending outwardly from the center hole 34. The radial slot 38 is adapted to receive the second disc member 16 and further has an end portion 37 to accommodate tab 30 when the second disc member 16 is sandwiched between the first and third disc members 12, 14. The third disc member 14 further includes an opaque portion 39 about the center hole 34. The opaque portion 39 advantageously is larger in diameter than the second disc member 16. Indicia 40 representing degrees from 0 to 360, and lines associated therewith, are located around the periphery of the third disc member 14.

As best shown in FIG. 1, a brass grommet 42, or other similar fastener, secures the second and third disc members 16, 14 together such that the second disc member 16 may rotate through the slot 38 and between the first and third disc member 12, 14, which are stationary, so that the second disc member 16 can indicate at least one of the indicia 40. Advantageously, the opaque portion 39 of the third disc member 14 covers at least a portion 16a of the second member 16.

As further shown in FIG. 1, to use the protractor 10, the center point 18 is placed over the vertex 19 of two intersecting lines 43 and 44. The 0 degree mark on the protractor 10 is lined up with one line 43, i.e. one side of the angle (θₐ), so that the angle (θₐ) can be measured by moving the second disc member 16 in a clockwise direction. The protractor 10 is held steady as the second disc member 16, being colored red, is rotated around by moving the tab 30, such as by utilizing the boss portion 35, until the marked straight edge 32 of tab 30 lines up with the second line 44. Notably, the coloring of the second disc member 16 helps to produce a visual display of the measured angle (θₐ) shown in FIG. 1 as being about 24 degrees.

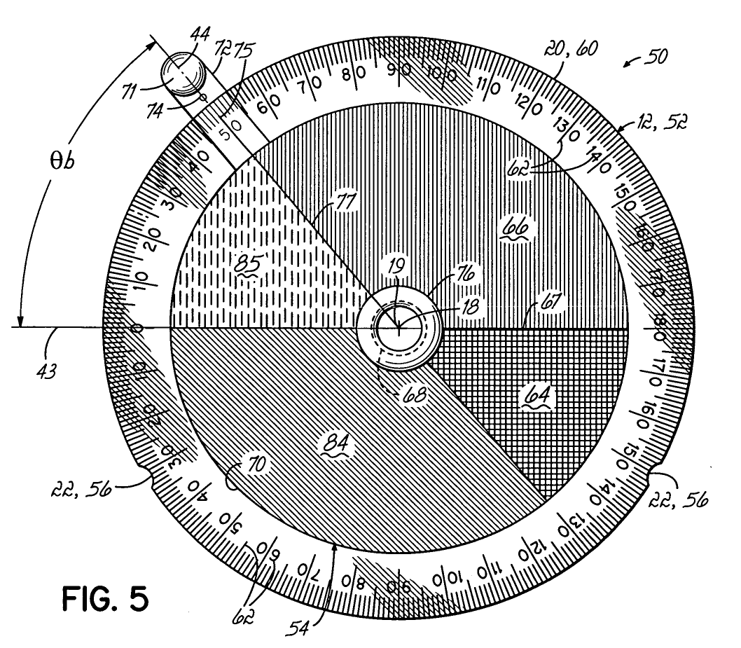

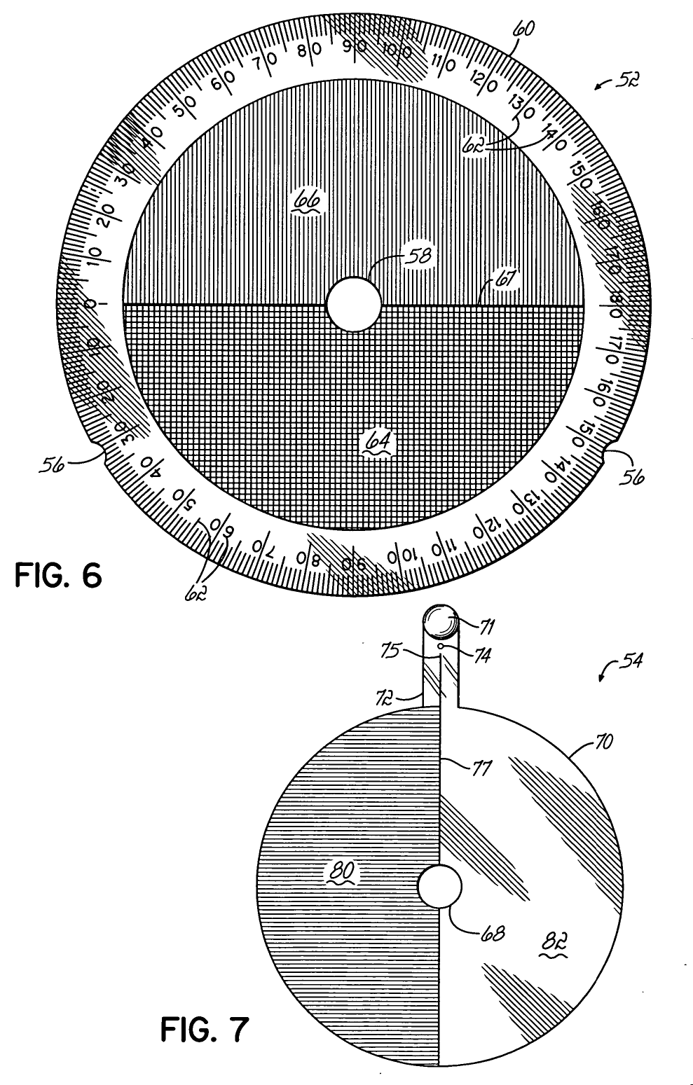

FIGS. 5-7 illustrate a second aspect of the present invention known as a 180 degree angle finder or protractor 50. FIG. 5 shows the angle finder 50 as assembled. Although not separately shown, the angle finder 50 has a generally flat clear first disc member 12 similar to the first disc member 12 shown in FIG. 2. Adhesive (not shown) is secured around the periphery of the first disc member 12 in order to secure a second disc member 52, shown in FIG. 6, to the first disc member 12. Any other desired securing means, e.g. tape, may be used for joining the first and second discs 12, 52 together. A third disc member 54, shown in FIG. 7, is rotatably secured on top of the second disc member 52.

Referring to FIGS. 2 and 5, the first disc member 12 of protractor 50 has a center point 18 and an outside or peripheral edge 20. When assembled, the center point 18 of the first disc member 12 is located in the center of a center hole 58 of the second disc member 52. As best shown in FIG. 5, the center point 18 is adapted for placement over the vertex 19, i.e. the intersection of the two lines 43 and 44, when the angle finder 50 is used to measure an angle (θ_{b}) between the lines 43, 44. Along the outside edge 20 of the first disc member 12 are two indentations or markers 22 which match up with the markers 56 on the second disc member 52 as shown in FIG. 6.

FIG. 6 illustrates the second disc member 52 having a circular center hole 58 and an outer or peripheral edge 60. A portion of the second disc member 52 advantageously is divided into two semi-circles 64, 66, the first semi-circle 64 being colored yellow and the second semi-circle 66 being colored red. Other colors, or lack thereof, may be used if desired. The two semi-circles are divided by a line segment 67 extending substantially across the second disc member 52. Indicia 62 representing degrees from 0 to 180, and lines associated therewith, are located around the periphery of each semi-circle 64, 66 of the second disc member 52. The indicia 62 advantageously may be colored red and green such that the red indicia are associated with the second semi-circle 66 and the green indicia are associated with the first semi-circle 64.

FIG. 7 (not drawn to scale) illustrates the third disc member 54 having a circular center hole 68, an outer or peripheral edge 70, and a tab 72 extending outwardly from the outer edge 70 of the periphery. The third disc member 54 advantageously is divided into two semi-circles 80, 82, the first semi-circle 80 being colored blue and the other semi-circle 82 being translucent, e.g. clear. It is understood that any number of other colors, or lack thereof, may be used for the two semi-circles. The two semi-circles 80, 82 are divided by a line segment 77 extending substantially across the third disc member 54. The tab 72 has a hole 74 therein, which enables a user to mark a spot with a dot and later draw a straight line from the center of the protractor 50 to the dot, and has a boss portion 71 for easier movement thereof. The tab 72 further includes one end 75 of the line segment 77 which helps a user indicate the indicia 62 when determining the measured angle (θ_{b}) (See FIG. 5).

Referring again to FIGS. 5-7, a brass grommet 76 or other similar fastener secures the second and third disc members 52, 54 together such that the third disc member 54 may rotate relative to the stationary second disc member 52 fixed on top of the first disc member 12. Notably, when the blue semi-circle 80 of the third disc member 54 is rotated over a portion of the yellow semi-circle 64, the result is a green color 84, and when the blue semi-circle 80 is placed over the red semi-circle 66, the result is a purple color 85. Thus, the user may easily distinguish measured angles using color, which can be a useful teaching device for young children.

As best shown in FIG. 5, to use the angle finder 50, the center point 18 is placed over the vertex 19 of two intersecting lines 43 and 44. Notably, the indicia 62 extend around the angle finder 50 from 0 to 180 degrees in both a clockwise and counterclockwise direction such that the 0 degree mark on one side of the angle finder 50 is associated with the 180 degree mark on the other side via line segment 67. This arrangement of the indicia 62 allows a user to choose to measure the angle (θ_{b}) in either a clockwise or counterclockwise direction. Specifically, the 0 degree mark on the protractor 50 is to be lined up with one of the two lines 43, 44 forming the angle (θ_{b}) so that the angle (θ_{b}) can be measured by moving the third disc member 54 in one of a clockwise or counterclockwise direction. In FIG. 5, line 43 is lined up with 0 degree mark so that the angle (θ_{b}) can be measured by moving the third disc member 54 in a clockwise direction. Next, the protractor 50 is held steady as the third disc member 54 is rotated by moving the tab 72, such as by utilizing the boss portion 71, until line segment 77 lines up with the second line 44.

Accordingly, the coloring of the second and third disc members 52, 54 helps to produce a visual display, i.e. purple color 85, of the measured angle (θ_{b}) shown here in FIG. 5 as being about 50 degrees. Alternatively, the third disc member 54 may be rotated counterclockwise to measure the angle (θ_{b}), and produce a yellow color, if line 44 is lined up with the 0 degree mark and the third disc member 54 is rotated until the line segment 77 lines up with line 43.

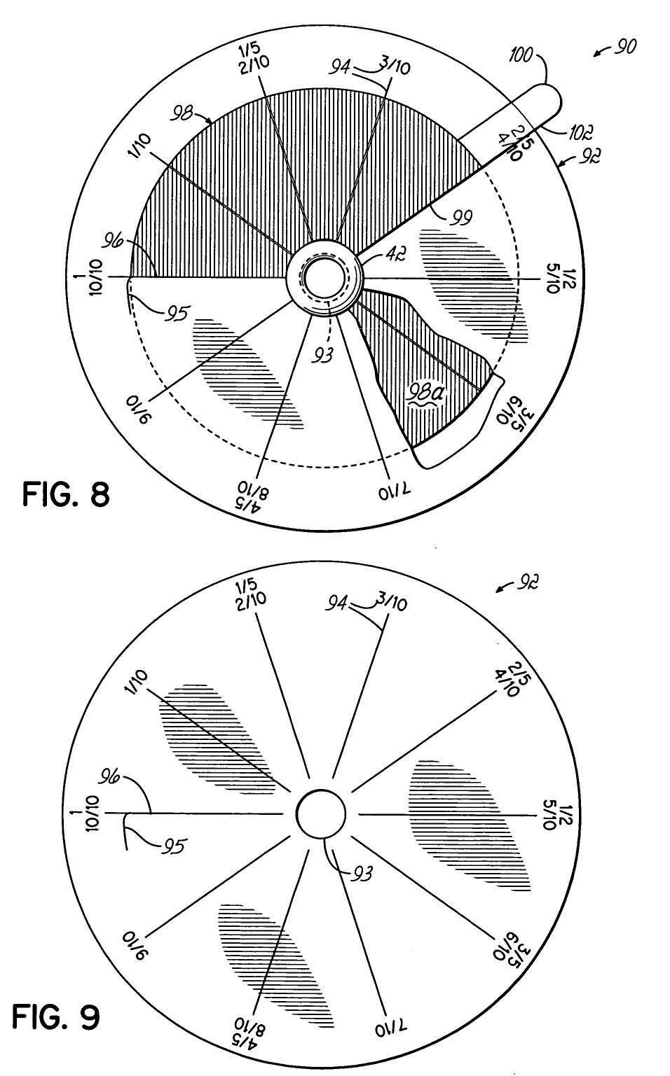

FIGS. 8-10 illustrates a third aspect of the present invention known as a fraction finder which helps students visualize parts of a whole, understand the meaning of denominator and numerator, rename fractions and/or add and subtract fractions. The fraction viewer 90 comprises two, i.e. first and second, flat disc members 92, 98 rotatably joined together and is used to teach students about fractions.

As best shown in FIG. 9, the first flat disc member 92 is a backing member which has a center hole 93, a radial slot 96 therein, and indicia 94 representing fractions, i.e. tenths of a fraction, and lines associated therewith, along the outer periphery thereof. The radial slot 96 is adapted to receive the second disc member 98 and further has an end portion 95 to accommodate a tab 100 of the second disc member 98 when the second disc member 16 is rotated behind the first disc member 92 (See FIG. 8). The first disc member 92 advantageously is opaque in color, and more advantageously white.

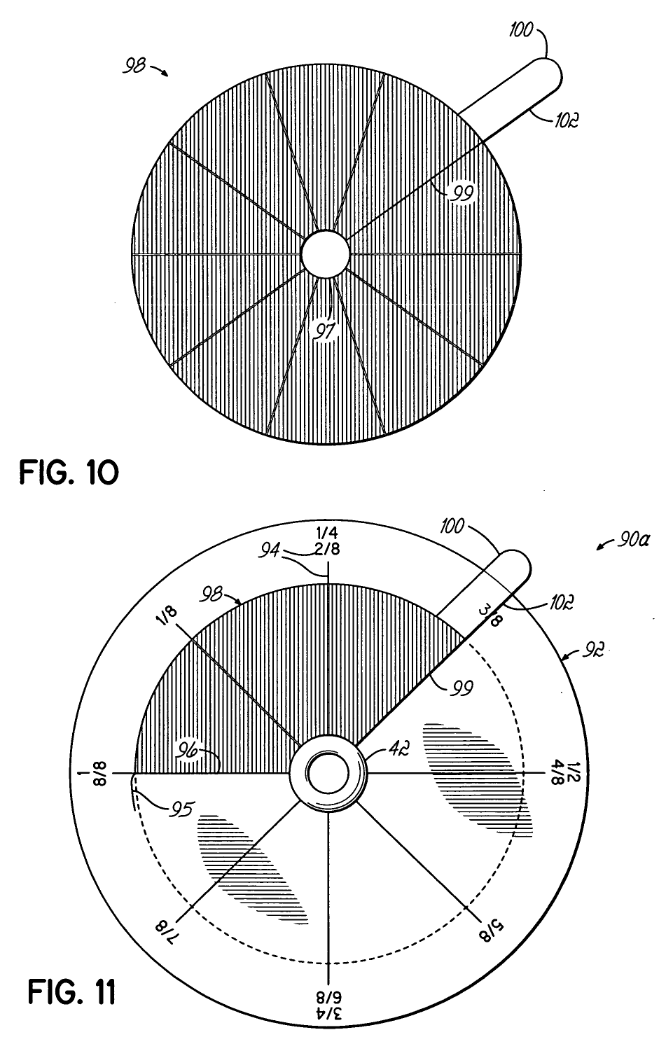

As best shown in FIG. 10, the second disc member 98 includes a center hole 97, has a radial slit 99 therein, and is substantially colored, advantageously red, to help a user to visualize the indicia 94. The second disc member 98 is rotatably joined to the first disc member 92 and further has the tab 100 extending outwardly from its outer edge 101 to enable a user to grasp the tab to rotate the second disc member 98. The tab 100 further has a straight edge 102 on one side which helps a user indicate the indicia 94.

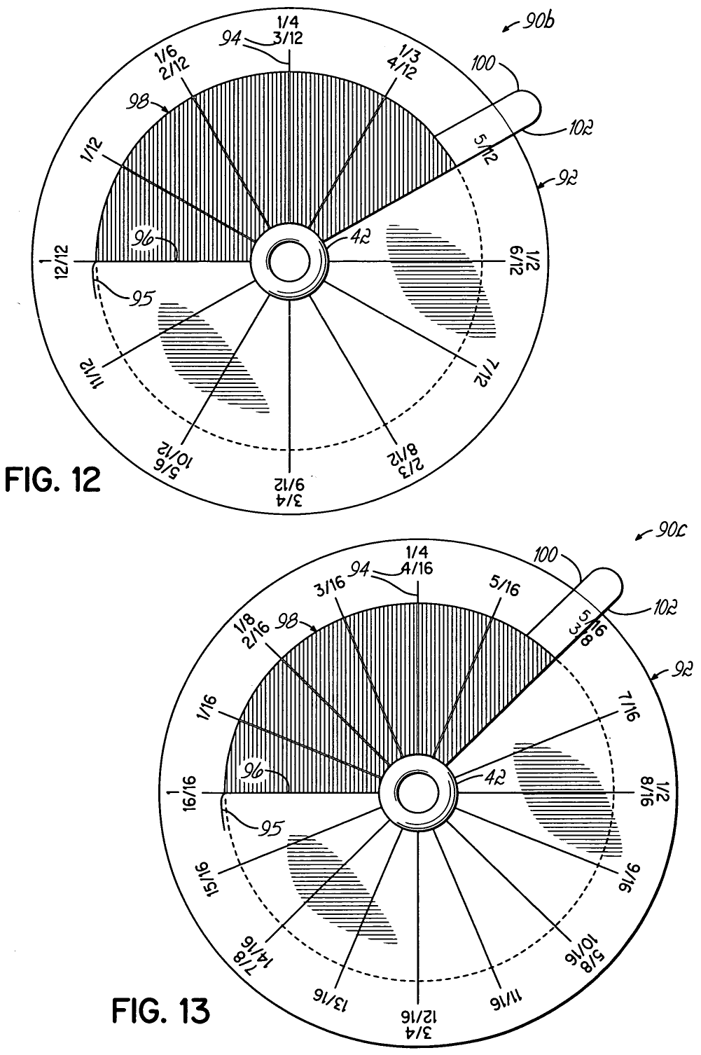

Referring again to FIGS. 8-10 a brass grommet 42, or other similar fastener, secures the first and second disc members 92, 98 together such that the second disc member 98 may rotate through the slot 96 and above and below the first disc member 92 when a user moves the tab 100 to indicate one of the indicia 94. Although the indicia 94 in FIG. 8 show tenths of a fraction, it is understood that the indicia 94 may represent any number of fractions. For example, FIGS. 11-13 show fraction viewers 90a-c with indicia 94 on the first disc members 92 being divided respectively into eighths, twelfths, and sixteenths.

To use the fraction viewer 90, a user rotates the second disc member 98 around to one of a desired indicia 94 located on the first disc member 92 by moving the tab 100 of the second disc member 98 until the edge 102 lines up therewith. Advantageously, the opaque coloring of the first disc member 92 covers a portion 98a of the second member 98 that is rotated behind the first disc member 92. Accordingly, the coloring of the second disc member 98 helps to produce a visual display of the viewed fraction shown in FIG. 8 as 4/10ths (or ⅖ths). In addition, the fractions indicated in FIGS. 11-13 respectively are ⅜ths, 5/12ths, and 5/16ths (or ⅜ths).

Although I have described several preferred embodiments of our invention, I do not intend to be limited except by the scope of the following claims.

1. A visual device for measuring angles, comprising:
a first disc member;
a colored second disc member; and
a third disc member secured to the first disc member and having indicia around a periphery thereof, the colored second disc member being rotatably connected to the third disc member to indicate at least one of the indicia.

2. The visual device of claim 1 wherein the second disc member is colored red.

3. The visual device of claim 1 wherein the third disc member includes an opaque portion adapted to cover at least a portion of the second disc member.

4. The visual device of claim 1 wherein the second disc member includes a radial slit and wherein the third disc member includes a radial slot adapted to receive at least a portion of the second disc member so that the second disc member is rotatably movable between the radial slot of the third disc member.

5. The visual device of claim 1 wherein the indicia represent degrees from 0 to 360.

6. The visual device of claim 1 wherein the first disc member defines a center point for placement over a vertex of an angle.

7. The visual device of claim 1 wherein the second disc member includes an outer edge having a tab extending outwardly therefrom to allow a user to rotate the second disc.

8. The visual device 7 of claim wherein the tab includes a marked edge to allow a user to indicate at least one of the indicia.

9. A visual device for measuring angles, comprising:
a first disc member;
a bi-colored second disc member secured to the first disc member and having indicia around a periphery thereof; and
a partly colored third disc member rotatably connected to the second disc member to indicate at least one of the indicia.

10. The visual device of claim 9 wherein the bi-colored second disc member includes two semi-circles with one semi-circle being colored yellow and the other being colored red.

11. The visual device of claim 10 wherein the partly colored third disc member includes two semi-circles with one semi-circle being colored blue and the other being translucent.

12. The visual device of claim 9 wherein the indicia represent two sets of degrees from 0 to 180.

13. The visual device of claim 9 wherein the first disc member defines a center point for placement over a vertex of an angle.

14. The visual device of claim 9 wherein the third disc member includes an outer edge having a tab extending outwardly therefrom to allow a user to rotate the second disc.

15. The visual device of claim 14 wherein the tab includes a hole therein adapted to allow a user to mark a spot with a drawing device.

16. The visual device of claim 14 wherein the tab includes a line to allow a user indicate at least one of the indicia.

17. A visual device for viewing fractions, comprising:
a first disc member having indicia around a periphery thereof, and
a substantially colored second disc member being rotatably connected to the first disc member to indicate at least one of the indicia.

18. The visual device of claim 17 wherein the second disc member is substantially colored red.

19. The visual device of claim 18 wherein the first disc member is substantially colored white.

20. The visual device of claim 17 wherein the second disc member includes a radial slit and wherein the first disc member includes a radial slot adapted to receive at least a portion of the second disc member so that the second disc member is rotatably movable between the radial slot of the first disc member.

21. The visual device of claim 17 wherein the second disc member includes an outer edge having a tab extending outwardly therefrom to allow a user to rotate the second disc.

22. The visual device of claim 17 wherein the indicia represent fractions.
